(19) United States
(12) Patent Application Publication
(10) Pub. No.: US 2012/0112460 A1
(43) Pub. Date: May 10, 2012

(54) PROBING POWER OPTIMIZATION FOR WIND FARMS

(75) Inventor: Martin Ansbjerg Kjær, Harlev J (DK)

(73) Assignee: VESTAS WIND SYSTEMS A/S, Aarhus N (DK)

(21) Appl. No.: 13/334,550

(22) Filed: Dec. 22, 2011

(51) Int. Cl. F03D 9/00

(52) U.S. Cl. 290/44

(57) ABSTRACT

Embodiments of the invention are generally related to optimizing performance of a wind power plant. A controller may be configured to sequentially, for each wind turbine in a wind power plant, adjust the power production by a predefined amount, and determine whether the adjustment of power production from the wind turbine results in an increase in overall power production from the wind farm. Adjustments in power production of the wind turbines may be continuously made so that power production of the wind power plant approaches the maximum possible value.

### FIELD OF THE INVENTION

Embodiments of the invention generally relate to wind turbine farms, and more specifically to improving the performance of wind turbine farms.

### BACKGROUND

In recent years, there has been an increased focus on reducing emissions of greenhouse gases generated by burning fossil fuels. One solution for reducing greenhouse gas emissions is developing renewable sources of energy. Particularly, energy derived from the wind has proven to be an environmentally safe and reliable source of energy, which can reduce dependence on fossil fuels.

Energy in wind can be captured by a wind turbine, which is a rotating machine that converts the kinetic energy of the wind into mechanical energy, and the mechanical energy subsequently into electrical power. Common horizontal-axis wind turbines include a tower, a nacelle located at the apex of the tower, and a rotor that is supported in the nacelle by means of a shaft. The shaft couples the rotor either directly or indirectly with a rotor assembly of a generator housed inside the nacelle. A plurality of wind turbines generators may be arranged together in a wind farm/park or wind power plant to generate sufficient energy to support a grid.

In general each turbine in a wind farm is configured to extract maximum possible energy from the wind. When wind turbines are lined up one behind another in relation to the wind direction, it is likely that the first turbine will extract the maximum possible energy from the wind. The remaining turbines behind the first turbine will extract relatively less power because they are in the wake of the first turbine.

### SUMMARY OF THE INVENTION

Embodiments of the invention generally relate to wind turbine farms, and more specifically to improving the performance of wind turbine farms.

One embodiment of the invention provides a method for a method for optimizing power production in a wind farm comprising, sequentially for each turbine in the wind farm:
(a) adjusting the power production from a wind turbine by a predefined amount;
(b) determining whether the adjustment of power production from the wind turbine results in an increase in overall power production from the wind farm;

(c) upon determining that the overall power production has increased, continuously repeating steps (a)-(b) until an increase in power production is not detected; and
(d) upon determining that the overall power production has not increased, selecting a next turbine for optimization.

Another embodiment of the invention provides a wind power plant, comprising a wind farm comprising a plurality of wind turbines; and a controller configured to optimize performance of the wind power plant by, sequentially for each turbine in the wind farm:
(a) adjusting the power production from a wind turbine by a predefined amount;
(b) determining whether the adjustment of power production from the wind turbine results in an increase in overall power production from the wind farm;
(c) upon determining that the overall power production has increased, continuously repeating steps (a)-(b) until an increase in power production is not detected; and
(d) upon determining that the overall power production has not increased, selecting a next turbine for optimization.

Yet another embodiment of the invention provides a controller for optimizing performance of a wind power plant, wherein the controller is configured to sequentially for each turbine in the wind farm:
(a) adjust the power production from a wind turbine by a predefined amount;
(b) determine whether the adjustment of power production from the wind turbine results in an increase in overall power production from the wind farm;
(c) upon determining that the overall power production has increased, continuously repeat steps (a)-(b) until an increase in power production is not detected; and
(d) upon determining that the overall power production has not increased, select a next turbine for optimization.

### BRIEF DESCRIPTION OF THE DRAWINGS

Embodiments of the present invention are explained, by way of example, and with reference to the accompanying drawings. It is to be noted that the appended drawings illustrate only examples of embodiments of this invention and are therefore not to be considered limiting of its scope, for the invention may admit to other equally effective embodiments.

FIG. 1 illustrates an exemplary wind turbine according to an embodiment of the invention.

FIG. 2 illustrates an exemplary wind turbine nacelle according to an embodiment of the invention.

FIG. 3 illustrates an exemplary wind power plant control system according to an embodiment of the invention.

FIG. 4 is a flow diagram of exemplary operations to optimize wind power plant performance according to an embodiment of the invention.

### DETAILED DESCRIPTION

In the following, reference is made to embodiments of the invention. However, it should be understood that the invention is not limited to specific described embodiments. Instead, any combination of the following features and elements, whether related to different embodiments or not, is contemplated to implement and practice the invention.

Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

The following is a detailed description of embodiments of the invention depicted in the accompanying drawings. The embodiments are examples and are in such detail as to clearly communicate the invention. However, the amount of detail offered is not intended to limit the anticipated variations of embodiments; but on the contrary, the intention is to cover all modifications, equivalents, and alternatives falling within the spirit and scope of the present invention as defined by the appended claims.

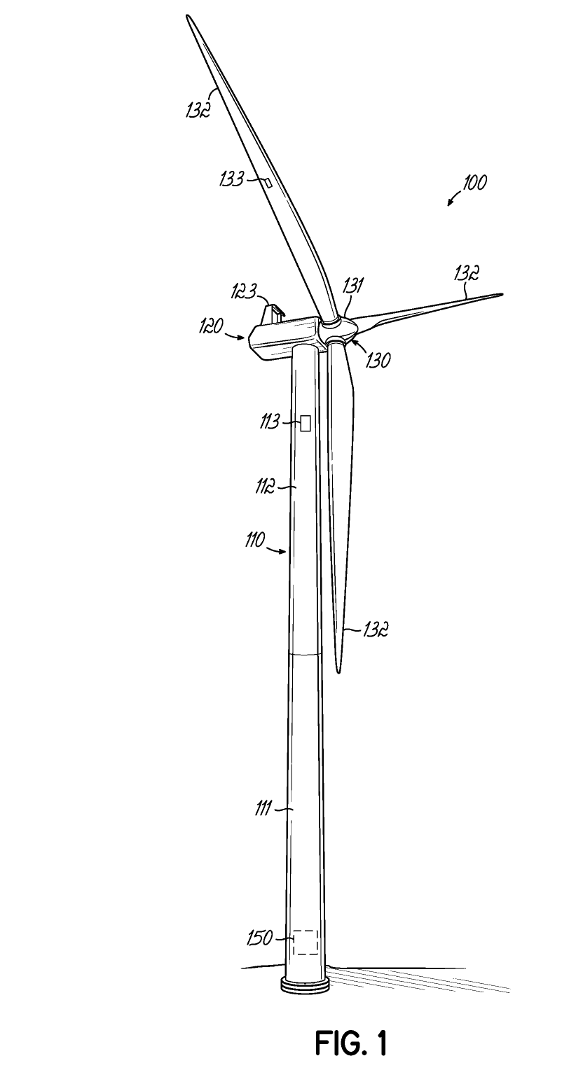

FIG. 1 illustrates an exemplary wind turbine 100 according to an embodiment of the invention. As illustrated in FIG. 1, the wind turbine 100 includes a tower 110, a nacelle 120, and a rotor 130. In one embodiment of the invention, the wind turbine 100 may be an onshore wind turbine. However, embodiments of the invention are not limited only to onshore wind turbines. In alternative embodiments, the wind turbine 100 may be an off shore wind turbine located over a water body such as, for example, a lake, an ocean, or the like.

The tower 110 of wind turbine 100 may be configured to raise the nacelle 120 and the rotor 130 to a height where strong, less turbulent, and generally unobstructed flow of air may be received by the rotor 130. The height of the tower 110 may be any reasonable height. The tower 110 may be made from any type of material, for example, steel, concrete, or the like. In some embodiments the tower 110 may be made from a monolithic material. However, in alternative embodiments, the tower 110 may include a plurality of sections, for example, two or more tubular steel sections 111 and 112, as illustrated in FIG. 1. In some embodiments of the invention, the tower 110 may be a lattice tower. Accordingly, the tower 110 may include welded steel profiles.

The rotor 130 may include a rotor hub (hereinafter referred to simply as the “hub”) 131 and at least one blade 132 (three such blades 132 are shown in FIG. 1). The rotor hub 131 may be configured to couple the at least one blade 132 to a shaft (not shown). In one embodiment, the blades 132 may have an aerodynamic profile such that, at predefined wind speeds, the blades 132 experience lift, thereby causing the blades to radially rotate around the hub. The nacelle 120 may include one or more components configured to convert aero-mechanical energy of the blades to rotational energy of the shaft, and the rotational energy of the shaft into electrical energy.

The wind turbine 100 may include a plurality of sensors for monitoring a plurality of parameters associated with, for example, environmental conditions, wind turbine loads, performance metrics, and the like. For example, a strain gauge 133 is shown on the blade 132. In one embodiment, the strain gauge 133 may be configured to detect bending and or twisting of the blades 132. The information regarding bending and twisting of the blades may be necessary to perform one or more operations that reduce the loads on the blades 132 that may occur, for example, during high wind gusts. In such situations, the blades may be pitched to reduce the loads, thereby preventing damage to the blades.

FIG. 1 also illustrates an accelerometer 113 that may be placed on the tower 110. The accelerometer 113 may be configured to detect horizontal movements and bending of the tower 110 that may be caused due to the loads on the wind turbine 100. The data captured by the accelerometer 113 may be used to perform one or more operations for reducing loads on the wind turbine 100. In some embodiments of the invention, the accelerometer 113 may be placed on the nacelle 120.

FIG. 1 also depicts a wind sensor 123. Wind sensor 123 may be configured to detect a direction of the wind at or near the wind turbine 100. By detecting the direction of the wind, the wind sensor 123 may provide useful data that may determine operations to yaw the wind turbine 100 into the wind. The wind sensor 123 may use the speed and direction of the wind to control blade pitch angle. Wind speed data may be used to determine an appropriate pitch angle that allows the blades 132 to capture a desired amount of energy from the wind or to avoid excessive loads on turbine components. In some embodiments, the wind sensor 123 may be integrated with a temperature sensor, pressure sensor, and the like, which may provide additional data regarding the environment surrounding the wind turbine. Such data may be used to determine one or more operational parameters of the wind turbine to facilitate capturing of a desired amount of energy by the wind turbine 100 or to avoid damage to components of the wind turbine.

In one embodiment of the invention, a light detection and ranging (LIDAR) device 180 may be provided on or near the wind turbine 100. For example, the LIDAR 180 may be placed on a nacelle, hub, and/or tower of the wind turbine, as illustrated in FIG. 1. In alternative embodiments, the LIDAR 180 may be placed in one or more blades 132 of the wind turbine 100. In some other embodiments, the LIDAR device may be placed near the wind turbine 100, for example, on the ground as shown in FIG. 1. In general, the LIDAR 180 may be configured to detect wind speed and/or direction at one or more points in front of the wind turbine 100. In other words, the LIDAR 180 may allow the wind turbine to detect wind speed before the wind actually reaches the wind turbine. This may allow wind turbine 100 to proactively adjust one or more of blade pitch angle, yaw position, and like operational parameters to capture greater energy from the wind, and reduce loads on turbine components. In some embodiments, a controller may be configured to combine the data received from a LIDAR device 180 and the wind sensor 123 to generate a more accurate measure of wind speed and/or direction.

While a strain gauge 133, accelerometer 113, and wind sensor 123 are described herein, embodiments of the invention are not limited to the aforementioned types of sensors. In general, any type and number of sensors may be placed at various locations of the wind turbine 100 to facilitate capturing data regarding structural health, performance, damage prevention, acoustics, and the like. For example, a pitch angle sensor may be placed at or near a wind turbine blade to determine a current pitch angle of the blade.

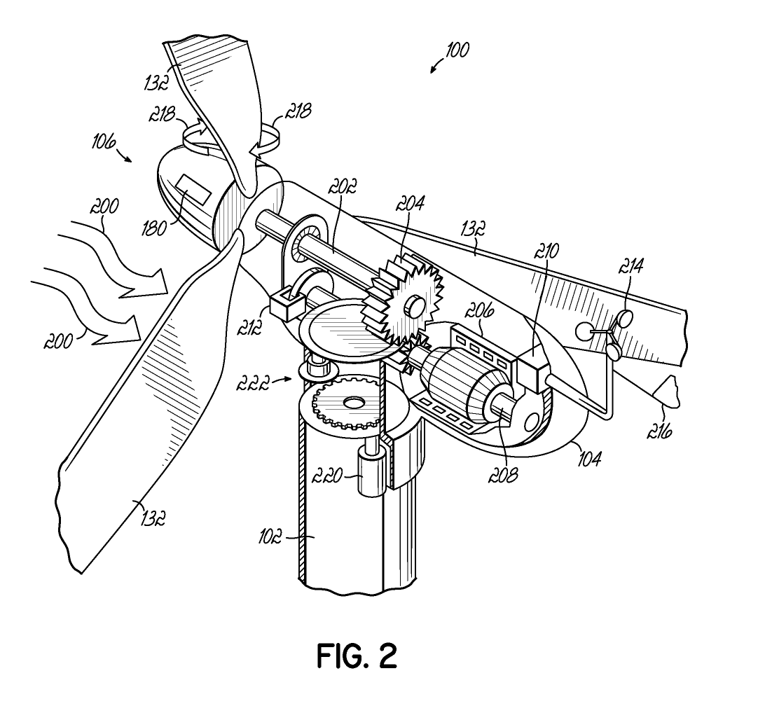

FIG. 2 illustrates a diagrammatic view of typical components internal to the nacelle 120 and tower 110 of a wind turbine generator 100. When the wind 200 pushes on the blades 132, the rotor 130 spins, thereby rotating a low-speed shaft 202. Gears in a gearbox 204 mechanically convert the low rotational speed of the low-speed shaft 202 into a relatively high rotational speed of a high-speed shaft 208 suitable for generating electricity using a generator 206. In an alternative embodiment, the gear box may be omitted, and a single shaft, e.g., the shaft 202 may be directly coupled with the generator 206.

A turbine controller 210 may sense the rotational speed of one or both of the shafts 202, 208. If the controller decides that the shaft(s) are rotating too fast, the controller may signal a braking system 212 to slow the rotation of the shafts, which slows the rotation of the rotor 106, in turn. The braking system 212 may prevent damage to the components of the wind turbine generator 100. The turbine controller 210 may also receive inputs from an anemometer 214 (providing wind speed) and/or a wind vane 216 (providing wind direction). Based on information received, the controller 210 may send a control signal to one or more of the blades 108 in an effort to adjust the pitch 218 of the blades. By adjusting the pitch 218 of the blades with respect to the wind direction, the rotational speed of the rotor (and therefore, the shafts 202, 208) may be increased or decreased. Based on the wind direction, for example, the controller 210 may send a control signal to an assembly comprising a yaw motor 220 and a yaw drive 222 to rotate the nacelle 104 with respect to the tower 102, such that the rotor 106 may be positioned to face more (or, in certain circumstances, less) upwind.

The generator 206 may be configured to generate a three phase alternating current based on one or more grid requirements. In one embodiment, the generator 206 may be a synchronous generator. Synchronous generators may be configured to operate at a constant speed, and may be directly connected to the grid. In some embodiments, the generator 206 may be a permanent magnet generator. In alternative embodiments, the generator 206 may be an asynchronous generator, also sometimes known as an induction generator. Induction generators may or may not be directly connected to the grid. For example, in some embodiments, the generator 206 may be coupled to the grid via one or more electrical devices configured to, for example, adjust current, voltage, and other electrical parameters to conform with one or more grid requirements. Exemplary electrical devices include, for example, inverters, converters, resistors, switches, transformers, and the like.

Embodiments of the invention are not limited to any particular type of generator or arrangement of the generator and one or more electrical devices associated with the generator in relation to the electrical grid. Any suitable type of generator including (but not limited to) induction generators, permanent magnet generators, synchronous generators, or the like, configured to generate electricity according to grid requirements falls within the purview of the invention.

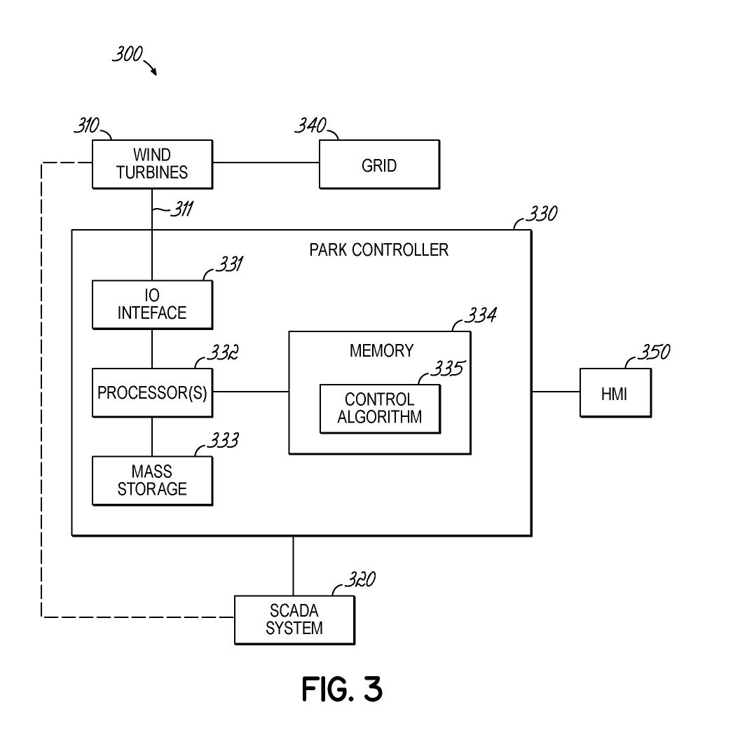

FIG. 3 illustrates an exemplary wind power plant 300 according to an embodiment of the invention. As illustrated, the wind power plant 300 may include a wind farm 310 coupled with a grid 340, a park controller 330, and a Supervisory Control And Data Acquisition (SCADA) system 320. The wind farm 310 may include one or more wind turbines, such as the representative wind turbine 100. The wind turbines collectively act as a generating plant ultimately interconnected by transmission lines with a power grid 340, which may be a three-phase power grid. The plurality of turbines of wind farm 310 may be gathered together at a common location in order to take advantage of the economies of scale that decrease per unit cost with increasing output. It is understood by a person having ordinary skill in the art that the wind farm 310 may include an arbitrary number of wind turbines of given capacity in accordance with a targeted power output.

The power grid 340 generally consists of a network of power stations, transmission circuits, and substations coupled by a network of transmission lines. The power stations generate electrical power by nuclear, hydroelectric, natural gas, or coal fired means, or with another type of renewable energy like solar and geothermal. Additional wind farms analogous to the wind farm 310 depicted may also be coupled with the power grid 340. Power grids and wind farms typically generate and transmit power using Alternating Current (AC).

The controller 330 can be implemented using one or more processors 331 selected from microprocessors, micro-controllers, digital signal processors, microcomputers, central processing units, field programmable gate arrays, programmable logic devices, state machines, logic circuits, analog circuits, digital circuits, and/or any other devices that manipulate signals (analog and/or digital) based on operational instructions that are stored in a memory 334. In one embodiment of the invention, the controller 330 may be configured to generate a power reference signals to each of the wind turbines in the wind farm 310. Based on the power reference signals 311 the wind turbines in the wind farm 310 may adjust one or more operational parameters, e.g., blade pitch angles, so that the wind farm produces a desired amount of power.

Memory 334 may be a single memory device or a plurality of memory devices including but not limited to read-only memory (ROM), random access memory (RAM), volatile memory, non-volatile memory, static random access memory (SRAM), dynamic random access memory (DRAM), flash memory, cache memory, and/or any other device capable of storing digital information.

Mass storage device 333 may be a single mass storage device or a plurality of mass storage devices including but not limited to hard drives, optical drives, tape drives, non-volatile solid state devices and/or any other device capable of storing digital information. An Input/Output (I/O) interface 331 may employ a suitable communication protocol for communicating with the wind turbines of wind farm 310.

Processor 332 operates under the control of an operating system, and executes or otherwise relies upon computer program code embodied in various computer software applications, components, programs, objects, modules, data structures, etc. to read data from and write instructions to one or more wind turbines of wind farm 310 through I/O interface 331, whether implemented as part of the operating system or as a specific application.

A human machine interface (HMI) 350 is operatively coupled to the processor 332 of the controller 330 in a known manner. The HMI 350 may include output devices, such as alphanumeric displays, a touch screen, and other visual indicators, and input devices and controls, such as an alphanumeric keyboard, a pointing device, keypads, pushbuttons, control knobs, etc., capable of accepting commands or input from the operator and transmitting the entered input to the processor 332.

As stated above, if a plurality of wind turbines are lined up one behind another in relation to the wind direction, the first turbine in the row may be capable of producing the highest amount of power because it received the full force of the wind. The remaining turbines may be in the wind shadow, or wake, of the first turbine. Because the first turbine extracts energy from the wind, the remaining turbines may not be able to produce as much power as the first turbine because they may experience lower wind speeds. This loss in ability to produce the maximum amount of power is commonly referred to as a wake loss.

In general, most turbines are configured to extract as much power from the wind as may be possible. However, in the aforementioned example, the first turbine may generate the greatest amount of power during its lifetime. This also means that the components of the first turbine are likely to undergo greater wear and tear, and that the remaining turbines may be under-utilized. Accordingly, it may be advantageous to reduce the power production from the first turbine to allow greater use and production from the remaining turbines in a row. Embodiments of the invention propose methods for managing the production of power from each turbine in a wind park so that the maximum amount of energy can be generated by the wind park as a whole.

In one embodiment, the model 336 may be used to determine the specific power reference (and therefore power production) from each turbine in a wind park. However, predefined models tend to be fraught with errors. Embodiments of the invention provide dynamic methods for determining the most desirable power references for each turbine in a wind park based on actual conditions and production.

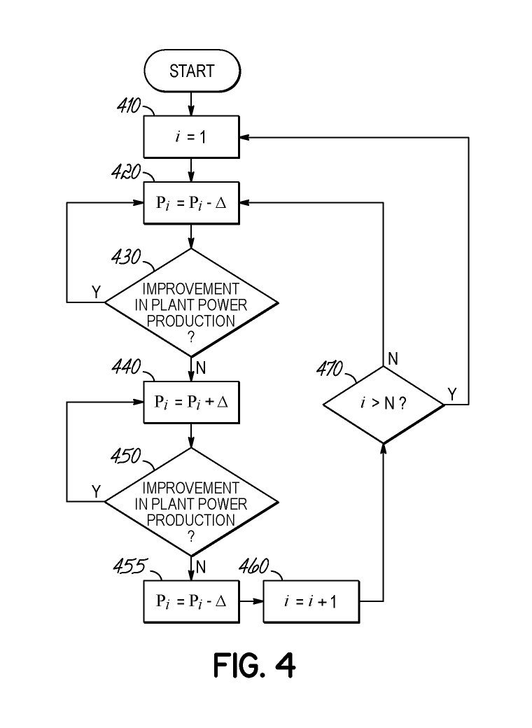

In one embodiment, the park controller may be configured to execute a control algorithm configured to determine the optimal power reference signals for each wind turbine in the wind farm 310. In a particular embodiment, the control algorithm may implement an iterative process of adjusting the power reference for each turbine in a wind farm until the optimal power reference for each turbine is found. As an example, assume that there are a total of N turbines in a wind farm. To determine the optimum power reference the each of the N turbines, the controller implementing the control algorithm may implement the process illustrated in FIG. 4.

As illustrated in FIG. 4, the process may begin in step 410 by selecting one of the turbines in the wind farm by setting the value of i to 1, wherein i is a turbine identifier ranging from 1 to N. In step 420, the power of the selected turbine (Pᵢ) is adjusted down by a value A. The value A may be any reasonable amount, for example, 10 kilowatts. Then, in step 430, the controller may determine whether there is an improvement in power production from the wind farm. If there is an improvement in production, this may indicate that further improvement may be possible by reducing power production from the selected turbine. Therefore, the process may move to step 420 if an improvement in power production is detected in step 430.

If there no improvement in power production is detected in step 430, the controller may go to step 440, wherein the power may be adjusted upwards by a value A. Thereafter, in step 450, the controller may determine whether there is in improvement in power production from the wind farm. If there is an improvement in production, this may indicate that further improvement may be possible by increasing power production from the selected turbine. Therefore, the process may move to step 440 if an improvement in power production is detected in step 450.

If no improvement in power production is detected in step 450, this may indicate that no further improvement in power production of the wind farm is possible by adjusting the power production from the selected wind turbine any further. Accordingly, the controller may go to step 455 where the wind turbine power is reduced by A to return to the previously calculated power value which was deemed to be the maximum power production value. Thereafter, in step 460, i may be incremented by 1 to select a new turbine. In step 470, the controller may determine whether the incremented value of i is greater than N. If yes, the controller goes to step 410 where i is set again to 1. On the other i is not determined to be greater than N in step 470, the controller goes to step 420 to repeat the iterative process for the newly selected turbine.

By executing the algorithm outlined in FIG. 4, over time, the power references for the turbines in the wind farm will approach the most optimum levels, thereby improving performance of the wind farm.

While the method steps in FIG. 4 are described with reference to plant controller 330, in alternative embodiments, any controller in the wind power plant may be configured to perform one or more of the steps shown in FIG. 4. For example, in one embodiment, the steps shown in FIG. 4 may be performed by a wind turbine controller in a power plant where the wind turbines are connected to each other via a network for sharing data and control signals. In some embodiments, some of the method steps of FIG. 4 may be performed by a plant controller while other steps may be performed by the turbine controller. For example, in one embodiment, steps 420-450 may be performed by a turbine controller, while steps 410, 460, and 470 may be performed by a plant controller.

By providing methods that improve the performance of wind turbines in a wind park through an iterative probine process, embodiments of the invention obviate the need for wind farm performance enhancing models which can be erroneous in predicting the optimum power settings for the wind turbines in the wind park.

While the invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative methods, and illustrative examples shown and described. Accordingly, departures may be made from such details without departing from the spirit or scope of applicant's general inventive concept.

What is claimed is:

1. A method for optimizing power production in a wind farm comprising, sequentially for each turbine in the wind farm:
(a) adjusting the power production from a wind turbine by a predefined amount;
(b) determining whether the adjustment of power production from the wind turbine results in an increase in overall power production from the wind farm;
(c) upon determining that the overall power production has increased, continuously repeating steps (a)-(b) until an increase in power production is not detected; and
(d) upon determining that the overall power production has not increased, selecting a next turbine for optimization.

2. The method of claim 1, wherein adjusting power production from the wind turbine comprises reducing the power produced by the wind turbine.

3. The method of claim 1, wherein adjusting power production from the wind turbine comprises increasing the power produced by the wind turbine.

4. The method of claim 1, wherein the method steps (a)-(d) are performed by a power plant controller.

5. The method of claim 1, wherein one or more of the method steps (a)-(d) are performed by a turbine controller.

6. A wind power plant, comprising:
a wind farm comprising a plurality of wind turbines;
and a controller configured to optimize performance of the wind power plant by, sequentially for each turbine in the wind farm:
(a) adjusting the power production from a wind turbine by a predefined amount;
(b) determining whether the adjustment of power production from the wind turbine results in an increase in overall power production from the wind farm;
(c) upon determining that the overall power production has increased, continuously repeating steps (a)-(b) until an increase in power production is not detected; and
(d) upon determining that the overall power production has not increased, selecting a next turbine for optimization.

7. The wind power plant of claim 7, wherein adjusting power production from the wind turbine comprises reducing the power produced by the wind turbine.

8. The wind power plant of claim 7, wherein adjusting power production from the wind turbine comprises increasing the power produced by the wind turbine.

9. The wind power plant of claim 7, wherein the controller is power plant controller.

10. The wind power plant of claim 7, wherein the controller is a wind turbine controller.

11. A controller for optimizing performance of a wind power plant, wherein the controller is configured to sequentially for each turbine in the wind farm:
(a) adjust the power production from a wind turbine by a predefined amount;
(b) determine whether the adjustment of power production from the wind turbine results in an increase in overall power production from the wind farm;
(c) upon determining that the overall power production has increased, continuously repeat steps (a)-(b) until an increase in power production is not detected; and
(d) upon determining that the overall power production has not increased, select a next turbine for optimization.

12. The controller of claim 11, adjusting power production from the wind turbine comprises reducing the power produced by the wind turbine.

13. The controller of claim 11, wherein adjusting power production from the wind turbine comprises increasing the power produced by the wind turbine.

14. The controller of claim 11, wherein the controller is power plant controller.

15. The controller of claim 11, wherein the controller is a turbine controller.
